(19) United States
(12) Patent Application Publication
(10) Pub. No.: US 2010/0054826 A1
(43) Pub. Date: Mar. 4, 2010

(54) WEB TRANSFER METHOD AND APPARATUS

(75) Inventor: TOYOAKI HIEDA, MINAMI-ASHIGARA-SHI (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/545,349

(22) Filed: Aug. 21, 2009

(30) Foreign Application Priority Data
Aug. 27, 2008 (JP) 2008-218225

(51) Int. Cl. G03G 15/16

(52) U.S. Cl. 399/313

(57) ABSTRACT

An aspect of the present invention provides a web transfer method comprising: a step of transferring a belt-like web; and a step of nipping both ends of the web by both end portions of a tiered roller and a pair of nip rollers, wherein the tiered roller is formed to have a larger diameter at the both end portions than at a central portion, and the pair of the nip rollers are arranged to incline outward in a transfer direction of the web to have an expansion angle.

### BACKGROUND OF THE INVENTION

1. Field of the Invention

The present invention relates to a web transfer method and apparatus, and more particularly, to a web transfer method and apparatus to transfer a web (a belt-like flexible support) by using a tiered roller so that a coated film surface of the web does not contact the roller.

2. Description of the Related Art

In general, a functional film such as a photosensitive material, an optical material used for a liquid crystal display apparatus, a gas barrier and the like is manufactured by transferring sequentially the web with the steps of delivering a uncoated web from a delivering device, coating the web with a functional coating solution, drying the coated film and winding up the web with the coated film to a winder. Rollers are provided between devices for the above steps to transfer the web, so the web is sequentially transferred. There are some kinds of the functional coating solutions having problems like deteriorated or altered by binding with oxygen in the air. Therefore, there are cases that a manufacturing line of the functional film is provided in a decompression chamber, and a transferring line is formed in a tunnel state and the tunnel is depressurized.

The coating solution is not coated across the full width of the web in the width direction. It is generally coated except on margins at the both ends of the web and the margins are eventually cut off.

The functional film drops significantly its own product's value when there are folds and flaws on the surface of the film because of a product characteristic. There is a general method to prevent the folds and the flaws such that a frictional force between a surface of the roller and the web is reduced by reducing a tension of the web being transferred, changing a material of the surface of the roller to a material with a low friction coefficient such as polytetrafluoroethylene (Teflon®), and making an angle (a wrap angle) of the web wrapping the roller smaller.

However, the countermeasures like changing the tension of the web, the material of the roller and the wrap angle of the web are not fundamental solutions because the frictional force between the web and the surface of the roller is generated to a greater or lesser degree.

For this reason, a tiered roller which can transfer the web with a noncontact technique is employed in Japanese Patent Application Laid-Open No. 2001-106402. A diameter of both ends of the tiered roller is formed bigger than a diameter of a midsection of the roller. The both ends of the roller support and transfer the both ends of the web (the margins). In this way, it is possible to prevent the midsection of the web (the section except the margins) from contacting the surface of the roller and damaging the coated surface even when the web is transferred with facing the coated surface of the functional coating solution to the tiered roller.

On the other hand, the tiered roller has a defect like that the midsection of the web hangs loose in the middle of the transfer and gets folds because of the tier between the both sides of the roller and the midsection of the roller. When the degree of hanging is big, the web contacts the midsection of the roller. To solve the defect, in the tiered roller of Japanese Patent Application Laid-Open No. 2001-106402, the midsection of the roller is formed to blow out air to support the midsection of the web and prevent it from hanging loose.

### SUMMARY OF THE INVENTION

However, the tiered roller of Japanese Patent Application Laid-Open No. 2001-106402 can not be used when the manufacturing line of the functional film must be provided in a decompression chamber because the tiered roller has a configuration such that air is blown out to prevent the web from hanging loose.

The present invention has been made in view of the above described circumstances. An object of the present invention is to provide a web transfer method and apparatus which is able to transfer the web not to have the folds by hanging loose the midsection of the web regardless of the ambient conditions of the web transfer such as at normal atmospheric pressure and in a vacuum state.

In order to achieve the object above, a first aspect of the present invention provides a web transfer method comprising a step of transferring a belt-like web, and a step of nipping both ends of the web by both end portions of a tiered roller and a pair of nip rollers, wherein the tiered roller is formed to have a larger diameter at the both end portions than at a central portion, and the pair of the nip rollers are arranged to incline outward in a transfer direction of the web to have an expansion angle.

According to the first aspect of the present invention, the both ends of the web which is transferred with being supported by the roller both end of which is formed to have the larger diameter than the roller midsection is nipped by the pair of the nip rollers, and the pair of the nip rollers are arranged to incline outward in the transfer direction of the web so that the web is transferred with being applied a force to expand outward in the width direction. Thus, the central portion of the web does not hang loose and get folds even when the web is transferred by the tiered roller. Also, the present invention does not have a configuration such that air is blown out to prevent the web from hanging loose, thereby the present invention can be used regardless of the ambient conditions of the web transfer such as at normal atmospheric pressure and in a vacuum state.

In addition, the present invention includes the case that the tiered roller rotates itself and makes the web transferred and the case that the tiered roller is rotated with being driven by the transfer of the web and support the web transfer. The case that the nip roller rotates itself and the case that the nip roller is rotated with being driven by the transfer of the web are included as well.

A second aspect of the present invention according to the first aspect provides the web transfer method, wherein the web has a predetermined wrapping angle relative to the tiered roller, and the pair of nip rollers nip the web at an immediately upstream position of a wrapping start position.

It is easier to expand the web in the width direction by the nip roller because the force of the roller both end to grip the web is weak at the immediately upstream position of a wrapping start position.

A third aspect of the present invention according to the second aspect provides the web transfer method, further comprising a step of nipping the web by another nip roller which is arranged at any position between the wrapping start position and a wrapping end position.

An expansion effect gets smaller at an immediately upstream position of the wrapping end position even when the web is expanded in the width direction at the adjacent position of the wrapping start position. Therefore, it is preferable to expand the web once again by another nip roller which is arranged at any position between the wrapping start position and the wrapping end position.

A fourth aspect of the present invention according to any one of the first to third aspects provides the web transfer method, when a transfer tension of the web is 100N or less, the expansion angle of the pair of nip rollers is set to 1.0° or more and 3.0° or less with a nip pressure of 10 Pa or more and 30 Pa or less, and when the transfer tension is more than 100N and equal to 150 or less, the expansion angle of the pair of nip rollers is set to more than 3° and less than 30° with the nip pressure of more than 30 Pa and equal to 60 Pa or less.

The preferable expansion angle to expand the web outward in the width direction tends to differ on reaching the transfer tension of the web of 100N. The expansion effect of the web outward in the width direction becomes better with the case that the transfer tension of the web is 100N or less, the preferable expansion angle is set to 1.0° or more and 3.0° or less, and the nip pressure is set to 10 Pa or more and 30 Pa or less at that time.

The expansion effect of the web outward in the width direction becomes better when the transfer tension of the web 14 is more than 100N and 150 or less, the expansion angle of the nip roller 16 is set to more than 3.0° and less than 30°. At the time, the nip pressure is set to more than 30 Pa and 60 Pa or less.

A fifth aspect of the present invention according to any one of the first to fourth aspects provides the web transfer method, wherein the web is an optical film and the optical film has a functional surface having an optical characteristic which faces to the tiered roller.

The present invention is especially effective for an optical film which has optical function characteristics adversely affected by a fine flaw and fold. Therefore, the web transfer must be performed in a decompression chamber of a low oxygen level because of the particularity of a coating solution.

A sixth aspect of the present invention provides a web transfer apparatus which transfers a belt-like web comprising: a tiered roller which supports both ends of the web with both end portions of the roller formed to have a larger diameter than a central portion of the roller; and a pair of nip rollers which nip the both ends of the web with the both end portions of the tiered roller and are arranged to incline outward in a transfer direction of the web to have an expansion angle.

The sixth aspect is a configuration of the present invention as an apparatus. The web transfer apparatus includes a tiered roller which supports both ends of the web with both end portions of the roller formed to have a larger diameter than a central portion of the roller; and a pair of nip rollers which nip the both ends of the web with the both end portions of the tiered roller and are arranged to incline outward in a transfer direction of the web to have an expansion angle. Thus, it is possible to transfer the web not to have the folds by hanging loose the midsection of the web regardless of the ambient conditions of the web transfer such as at normal atmospheric pressure and in the vacuum state.

A seventh aspect of the present invention provides the web transfer apparatus according to the sixth aspect, wherein the web has a predetermined wrapping angle relative to the tiered roller, and the pair of the nip rollers are arranged at an immediately upstream position of a wrapping start position.

In this way, the web can be smoothly expanded outward in the width direction.

An eighth aspect of the present invention provides the web transfer apparatus according to any one of the sixth to seventh aspects, wherein the pair of nip rollers include a nip pressure adjusting device and a expansion angle adjusting device.

In the present invention, the expansion angle and the nip pressure of the nip roller can be set to one value, but it is possible to set to the preferable expansion angle and nip pressure according to various properties of the web (a rupture strength, a degree of elasticity, thickness, a slipperiness against the nip roller and like) by providing the pressure adjusting device and the expansion angle adjusting device.

A ninth aspect of the present invention provides the web transfer apparatus according to any one of the sixth to eighth aspects, wherein the pair of nip rollers include a plurality of rollers arranged parallel to each other.

An expansion performance to expand the web outward in the width direction can be improved by providing the plurality of the nip rollers arranged parallel to each other.

A tenth aspect of the present invention provides the web transfer apparatus according to the ninth aspect, wherein an expansion angle of the plurality of the rollers is larger at the roller arranged outside than at the roller arranged inside.

According to the tenth aspect, the expansion angle of the plurality of the rollers is larger at the roller arranged outside than at the roller arranged inside so that the expansion force to expand the web outward in the width direction is gradually headed to the outside

An eleventh aspect of the present invention provides the web transfer apparatus according to any one of the sixth to tenth aspects, wherein the pair of nip rollers are rubber rollers.

A grip force of the rubber roller to grip the web is larger than a roller such as a metal roller and like formed by a hard material, so the performance to expand the web outward in the width direction gets better.

A twelfth aspect of the present invention provides the web transfer apparatus according to any one of the sixth to eleventh aspects, wherein the web transfer apparatus is provided in a decompression chamber.

That is because the web transfer apparatus of the present invention is especially effective when the apparatus is provided in the decompression chamber.

The degree of decompression in the decompression chamber is the degree of decompression not to occur the oxidation or the alteration of the coating solution and includes complete vacuum.

It is possible to transfer the web not to have the folds by hanging loose the midsection of the web regardless of the ambient conditions of the web transfer such as at normal atmospheric pressure and in a vacuum state according to the web transfer method and apparatus of the present invention.

Also, the present invention is easier and more reasonable than the configuration such that air is blown out to prevent the web from hanging loose.

### BRIEF DESCRIPTION OF THE DRAWINGS

FIG. 1 is a perspective view showing a concept of a web transfer apparatus according to the present invention;

FIG. 2 is a perspective view showing another embodiment of the web transfer apparatus according to the present invention which has a ring-shaped edge roller at the both ends;

FIG. 3 is an explanatory diagram explaining an expansion angle of a nip roller;

FIGS. 4A and 4B are tables showing substantiated data of a preferred expansion angle of the nip roller and a nip pressure;

FIG. 5 is an explanatory diagram explaining another embodiment the nip roller with a plurality of rollers arranged in parallel;

FIG. 6 is an explanatory diagram explaining a preferred arrangement position of the nip roller which is located at an adjacent position of a wrap start position;

FIG. 7 is a table showing substantiated data at the adjacent position of the wrap start position;

FIG. 8 is an explanatory diagram explaining an embodiment having a first and a second nip roller arranged; and

FIG. 9 is a diagram showing an application of the web transfer apparatus of the present invention to a manufacturing line of an optical film.

### DETAILED DESCRIPTION OF THE PREFERRED EMBODIMENT

In the following, a preferred embodiment of a web transfer method and apparatus according to the present invention will be described with reference to the accompanying drawings.

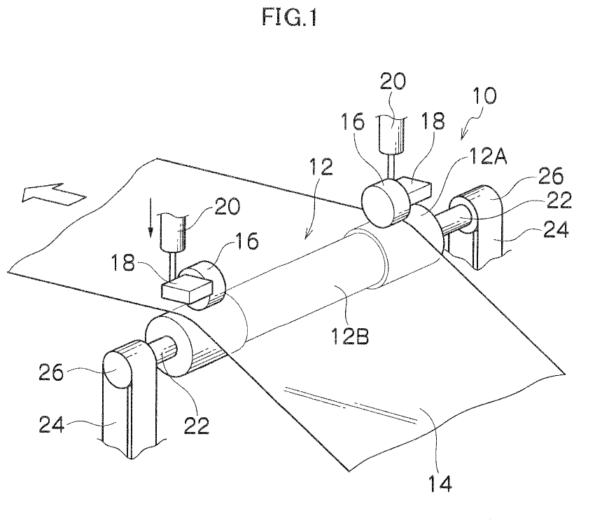

FIG. 1 is a perspective view showing a concept of a web transfer apparatus according to the present invention.

As shown in FIG. 1, a web transfer apparatus 10 mainly includes a tiered roller 12 which has a roller central portion 12B and roller end portions 12A having larger diameter than the roller central portion 12B, a pair of nip rollers 16, 16 for nipping a web 14 with the roller end portions 12A of the tiered roller 12 respectively and being arranged so that the pair of nip rollers 16, 16 have an expansion angle θ which becomes larger in the transfer direction of the web 14, an expansion angle adjusting device 18 for adjusting the expansion angle θ of the pair of nip rollers 16, 16, and a nip pressure adjusting device 20 for adjusting a nip pressure.

The expansion angle adjusting device 18 can be any devices as long as it is able to adjust the direction of the pair of nip rollers 16, 16 relative to the web transfer direction. For example, a steering mechanism which is used in a car and like can be preferably used. The nip pressure adjusting device 20 can be any devices as long as it is able to adjust the pressure of the nip roller 16 pressing the roller end portions 12A of the tiered roller 12 through the web 14. For example, an air cylinder can be preferably used.

As shown in FIG. 1, the tiered roller 12 is formed to have a diameter at the roller end portions 12A larger than a diameter at the roller central portion 12B. A rotating shaft 22, 22 is provided at the both ends of the tiered roller 12, and is rotatably supported by a bearing 26 which is fixed on a brace 24. The tiered roller 12 in FIG. 1 is rotated with being driven by the transfer of the web but the tiered roller 12 may take another method that the tiered roller 12 is synchronized with the transfer speed of the web 14 and driven. The difference between the diameters of the roller end portions 12A and the roller central portion 12B must be 0.1 mm or more. In such roller configuration of the present invention, it is possible to prevent the web 14 from contacting the roller central portion when the difference is 0.1 mm or more.

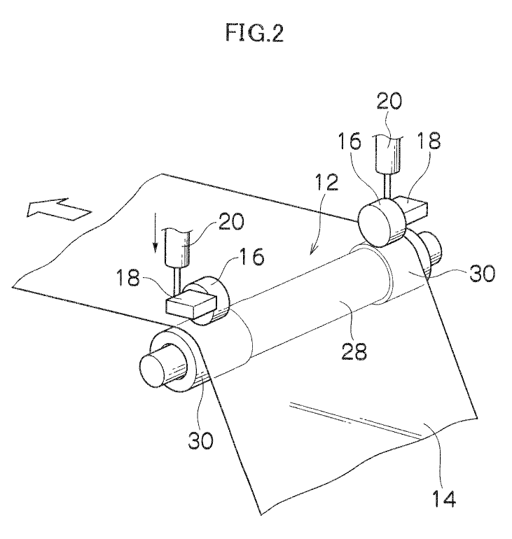

The tiered roller 12 of FIG. 1 is configured to have the roller end portions 12A and the roller central portion 12B integrally, and rotate the tiered roller 12 entirely by supporting the rotating shaft 22 with the bearing 26. On the other hand, as shown in FIG. 2, the configuration may be formed so that only a ring shaped edge roller 30 is driven to rotate by the web 14 by supporting the ring shaped edge roller 30 (which is equivalent to the roller end portions 12A in FIG. 1) through a bearing (not shown) at the both end of a center roller 28 formed to have the diameter of the roller central portion 12B.

A preferred material of the tiered roller 12 is a hard material such as a metal and like. The reason for this is that there is a possibility for the web 14 to get the folds when the tiered roller 12 is deflected with the transfer tension of the web 14, since the both ends of the web 14 are supported and transferred by the roller end portions 12A of the tiered roller 12.

As shown in FIG. 1, the pair of nip rollers 16, 16 are respectively arranged at the roller end portions 12A which is the larger diameter of the tiered roller 12, and nips the web 14 with the roller end portions 12A of the tiered roller 12. A material of a roller surface of the nip roller 16 may be a hard material such as a metal and like, but it is preferably formed with an elastic material such as a rubber and like. Thereby, a grip force of the nip roller 16 to grip the web 14 becomes larger.

The direction of the pair of nip rollers 16, 16 have an expansion angle which becomes larger in the transfer direction of the web 14. In other words, the nip roller 16 is provided so that the pair of nip rollers 16, 16 have the predetermined expansion angle θ relative to the transfer direction of the web 14.

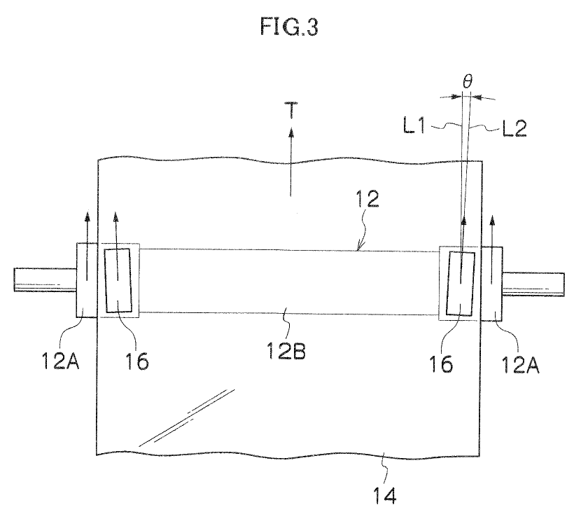

The expansion angle θ of the nip roller 16 is explained here with reference to FIG. 3. The expansion angle θ is how much an inclined angle line L2 (in the perpendicular direction to the axis of the nip roller 16) of the nip roller 16 is inclined to the both ends of the tiered roller 12 relative to a transfer direction line L1 (in the perpendicular direction to the axis of the tiered roller 12) of the web 14.

Also, the preferable expansion angle θ to expand the web 14 outward in the width direction differs on reaching the transfer tension of the web 14 of 100N.

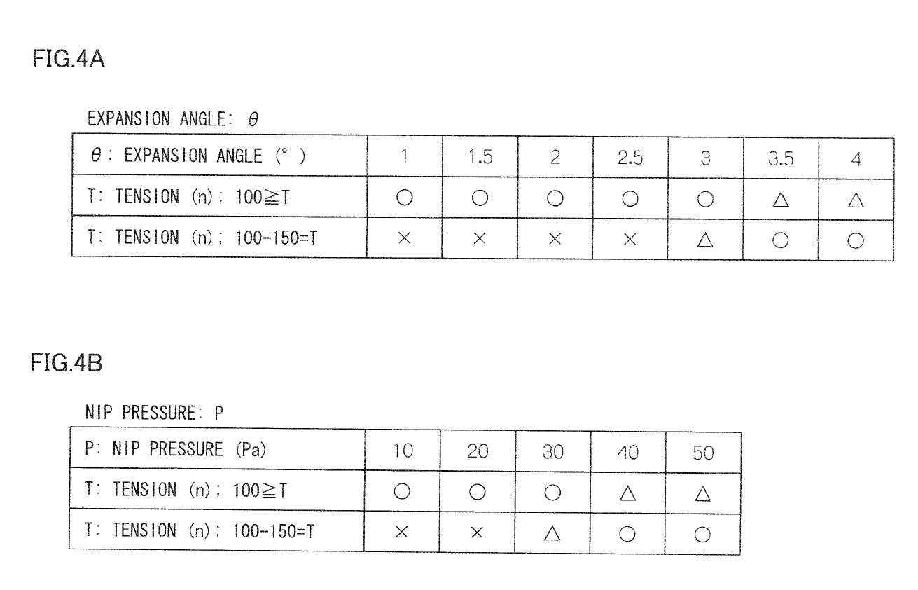

FIG. 4A shows data in a case that the web 14 having the width of 700 mm is transferred 100 m with the web transfer apparatus 10 of the present invention, and the expansion angle θ is set to seven levels such as 1.0°, 1.5°, 2.0°, 2.5°, 3.0°, 3.5° and 4.0° in increments of 0.5°. Additionally, the nip pressure is fixed to 30 Pa at the time. In a five times repeated test, G of FIG. 4A is the case that no fold is generated on the web 14, F of FIG. 4A is the case that the folds are generated constantly, and OK of FIG. 4A is the case that the folds are generated in some cases. F is a failure in case of the manufacturing line of the functional film but OK is good enough to pass an acceptable line in case of the functional film which does not have an exacting requirement about the folds. The existence of the folds is determined by a visual observation.

As a result, the expansion angle θ of 1.0° to 3.0° has the evaluation G when the transfer tension of the web 14 is 100N or less, and the evaluation is OK when the expansion angle θ is 3.5° and 4.0°. On the other hand, the expansion angle θ of 1.0° to 3.0° has the evaluation F when the transfer tension of the web 14 is more than 100N and equal to 150 or less. The evaluation is OK when the expansion angle θ is 3.0°, and the evaluation is G when the expansion angle θ is 3.5° and 4.0°. Then, the expansion angle θ is enlarged more and the evaluation stays G until the expansion angle θ of 30° (not shown in Figs).

FIG. 4B shows how the folds appear when the nip pressure differs with the condition of FIG. 4A that the expansion angle θ of 3.0° has the evaluation G when the transfer tension of the web 14 is 100N or less. The existence of the folds is tested when the nip pressure is set to five levels such as 10 Pa, 20 Pa, 30 Pa, 40 Pa, and 50 Pa in increments of 10 Pa with the condition of FIG. 4A that the expansion angle θ of 3.5° has the evaluation G when the transfer tension of the web 14 is more than 100N and equal to 150 or less. As a result, when the transfer tension of the web 14 is 100N or less, the evaluation is G with 100 Pa to 30 Pa, and OK with 40 Pa to 50 Pa. On the other hand, when the transfer tension of the web 14 is more than 100N and equal to 150 or less, the evaluation is F with 10 Pa to 20 Pa, OK with 30 Pa and G with 40 Pa to 50 Pa. Then, when the nip pressure is enlarged more, the evaluation stays G until 60 Pa (not shown in Figs).

From the test result of FIGS. 4A and 4B, the expansion angle θ of the nip roller 16 which is expanded outward in the width direction is preferably set to 1.0° or more and 3.0° or less when the transfer tension of web 14 is 100N or less. At the time, the nip pressure is preferably set to 10 Pa or more and 30 Pa or less. Additionally, when the transfer tension of the web 14 is more than 100N and 150 or less, the expansion angle of the nip roller 16 is preferably set to more than 3.0° and less than 30°. At the time, the nip pressure is preferably set to more than 30 Pa and 60 Pa or less.

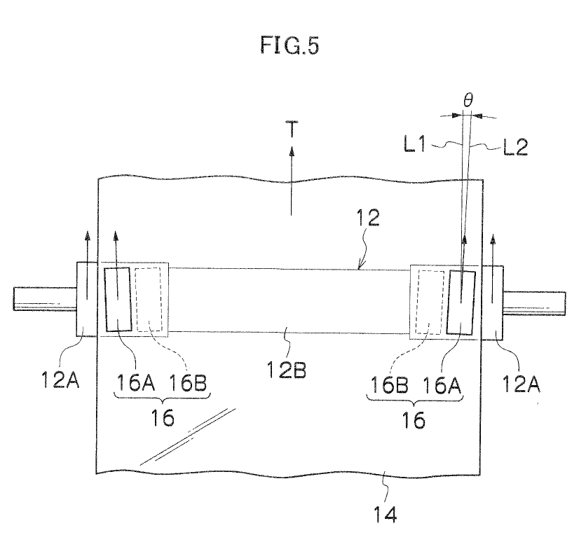

Moreover, in FIGS. 1 to 3, the case of that the pair of the nip roller 16, 16 is provided at the roller end portions 12A of the tiered roller 12 is explained, but the nip roller 16 more preferably includes a plurality of rollers 16A and 16B which are arranged parallel to each other. This case is more preferable because it is easier to make the web 14 to expand in the width direction by providing the plurality of rollers 16A and 16B so that the outer roller has the larger expansion angle than the inner roller. FIG. 5 shows that the two rollers 16A and 16B are arranged to be parallel to each other. The preferable number of the rollers depends on the width dimension of the both ends of the tiered roller 12 but it is preferable to provide more than two rollers on each end of the tiered roller 12 respectively. This is because the capability to expand the web 14 outward in the width direction is improved by configuring the nip roller 16 with the plurality of rollers which are arranged parallel to each other.

The web 14 is preferably wrapped around the tiered roller 12 with a wrap angle of 10° to less than 180°, more preferably 15° to 90° and transferred. At the same time, it is preferable that the nip roller 16 nips the web 14 at the adjacent position of the wrap start position.

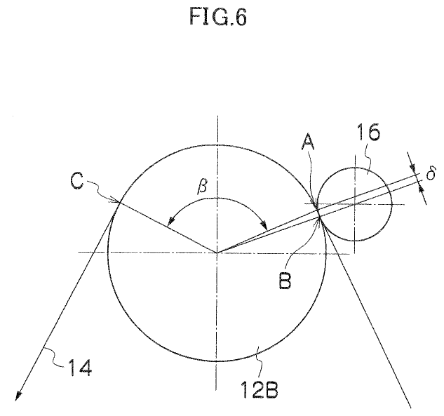

A preferable position to provide the nip roller 16 which is located at the immediately upstream position of the wrapping start position is described here with reference to FIG. 6. FIG. 6 shows the case that the web 14 is wrapped around the roller end portions 12A of the tiered roller 12 with the wrap angle of β. The wrapping start position is A and a wrapping end position is C. The nip roller 16 nips the web 14 at a nip position B which is located immediately upstream of the wrapping start position A in the web transfer direction with a distance δ of 1 to 2 mm, so that it is possible to prevent the generation of the folds more effectively.

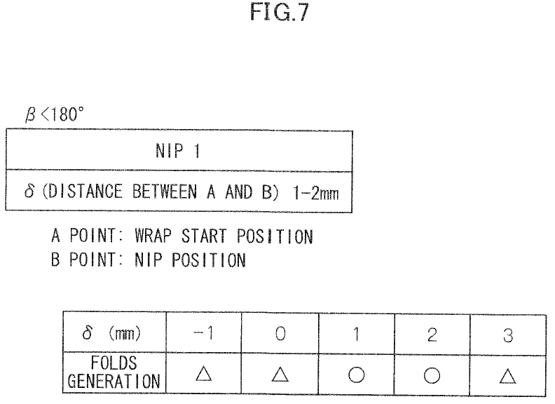

FIG. 7 shows the test result which is to determine how far the distance δ (mm), and δ shows the straight line between the wrapping start position A and the nip position B. The generation of the folds is examined when δ is set five levels such as −1 mm, 0 mm, 1 mm, 2 mm and 3 mm. When δ is a negative value, the nip position B is located downstream of the wrap start position in the web transfer direction Also, when δ is a positive value, the nip position B is located upstream of the wrapping start position in the web transfer direction, in other words, the nip roller 16 which is located at the adjacent position of the wrapping start position A. When δ is 0, the wrapping start position A and the nip position is same. The evaluation standards G and OK of the generation of the folds mean same as above (in FIGS. 4A and 4B).

Accordingly, when δ is −1 mm, 0 mm and 3 mm, the evaluation is OK. When δ is 1 mm to 2 mm, the evaluation is G. Thus, it is more preferable that δ is set to 1 to 2 mm from the wrapping start position.

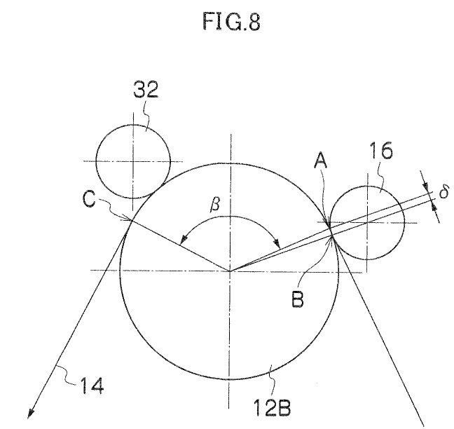

Moreover, when only one nip roller is used, it is preferable that the nip position B is located at the immediately upstream position of the wrapping start position. However, as the more preferable embodiment, an another nip roller 32 may be provided at any position between the wrapping start position A and the wrapping end position C as shown in FIG. 8. In this case, the expansion angle θ of the added nip roller 32 is preferably set to equal to or more than the expansion angle θ of the nip roller which is provided at the wrap start position. Thereby, the web 14 can be expanded in the width direction much more easily.

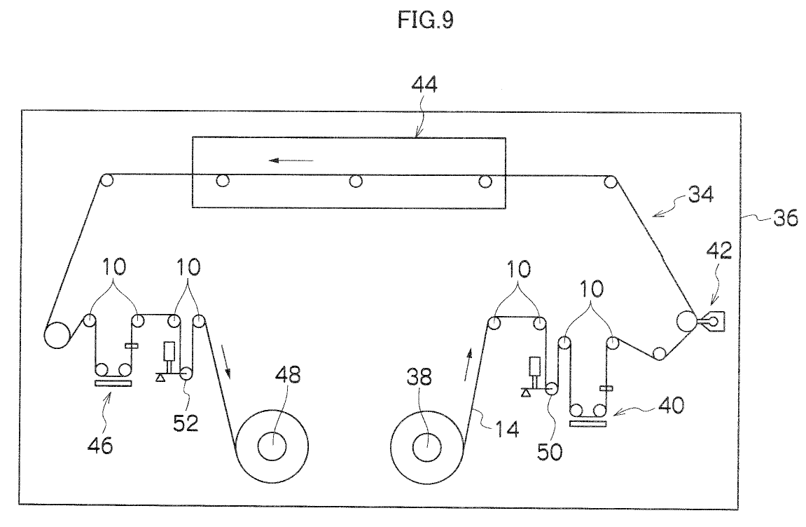

FIG. 9 shows an example of an arrangement that the web transfer apparatus 10 of the present invention is applied to a manufacturing line 34 of an optical film. The example if the case that the manufacturing line 34 is arranged in a decompression chamber 36. Parts which are painted black are the parts that the web transfer apparatus 10 of the present invention is used.

The uncoated web 14 fed from a feeding apparatus 38 is transferred to a coating apparatus 42 through a first EPC apparatus 40 in the manufacturing line 34 of the optical film in FIG. 9. A coating solution having an optical property is coated at the coating apparatus 42. Various coating methods such as an extrusion coating method, a rod coating method, a roll coating method, a gravure coating method and like can be used. Especially, the extrusion coating method is preferably used because a thin film coating with high accuracy is realized. The web 14 which is coated with the coating solution is dried at a dry apparatus 44 and then wound by a winding apparatus 48 through a second EPC apparatus 46. The transfer of the web 14 is performed by the winding apparatus 48 with winding. A first and second dancer roller 50 and 52 are provided between the feeding apparatus 38 and the first EPC apparatus 40, and between the second EPC apparatus 46 and the wining apparatus 48 respectively, thereby the transfer tension of the web 14 being transferred is maintained constant. The EPC apparatus of the present embodiment is the apparatus to keep the web 14 in a place so that the web 14 does not move in the width direction during the transfer. It is preferable that the EPC apparatus is provided near the web transfer apparatus 10 of the present invention.

The web transfer apparatus 10 of the present invention is able to perform a noncontact transfer in that the web surface to be coated with the coating solution before coating and the coated surface after the coating do not contact the roller. Furthermore, with the web transfer apparatus 10, the midsection of the web 14 does not hang loose and get the folds on the web 14 during the transfer.

What is claimed is:

1. A web transfer method comprising:
a step of transferring a belt-like web; and
a step of nipping both ends of the web by both end portions of a tiered roller and a pair of nip rollers, wherein
the tiered roller is formed to have a larger diameter at the both end portions than at a central portion, and
the pair of the nip rollers are arranged to incline outward in a transfer direction of the web to have an expansion angle.

2. The web transfer method according to claim 1, wherein
the web has a predetermined wrapping angle relative to the tiered roller, and
the pair of nip rollers nip the web at an immediately upstream position of a wrapping start position.

3. The web transfer method according to claim 2, further comprising
a step of nipping the web by an another nip roller which is arranged at any position between the wrapping start position and a wrapping end position.

4. The web transfer method according to claim 1, wherein
when a transfer tension of the web is 100N or less, the expansion angle of the pair of nip rollers is set to 1.0° or more and 3.0° or less with a nip pressure of 10 Pa or more and 30 Pa or less, and
when the transfer tension is more than 100 N and equal to 150 or less, the expansion angle of the pair of nip rollers is set to more than 3° and less than 30° with the nip pressure of more than 30 Pa and equal to 60 Pa or less.

5. The web transfer method according to claim 3, wherein
when a transfer tension of the web is 100N or less, the expansion angle of the pair of nip rollers is set to 1.0° or more and 3.0° or less with a nip pressure of 10 Pa or more and 30 Pa or less, and
when the transfer tension is more than 100N and equal to 150 or less, the expansion angle of the pair of nip rollers is set to more than 3° and less than 30 with the nip pressure of more than 30 Pa and equal to 60 Pa or less.

6. The web transfer method according to claim 1, wherein
the web is an optical film and the optical film has a functional surface having an optical characteristic which faces to the tiered roller.

7. The web transfer method according to claim 5, wherein
the web is an optical film and the optical film has a functional surface having an optical characteristic which faces to the tiered roller.

8. A web transfer apparatus for transferring a belt-like web comprising:
a tiered roller which supports both ends of the web with both end portions of the roller formed to have a larger diameter than a central portion of the roller; and
a pair of nip rollers which nip the both ends of the web with the both end portions of the tiered roller and are arranged to incline outward in a transfer direction of the web to have an expansion angle.

9. The web transfer apparatus according to claim 8, wherein
the web has a predetermined wrap angle relative to the tiered roller, and
the pair of nip rollers are arranged at immediately upstream position of a wrapping start position.

10. The web transfer apparatus according to claim 8, wherein
the pair of nip rollers include a nip pressure adjusting device and an expansion angle adjusting device.

11. The web transfer apparatus according to claim 9, wherein
the pair of nip rollers include a nip pressure adjusting device and an expansion angle adjusting device.

12. The web transfer apparatus according to claim 8, wherein
the pair of nip rollers include a plurality of rollers arranged parallel to each other.

13. The web transfer apparatus according to claim 11, wherein
the pair of nip rollers include a plurality of rollers arranged parallel to each other.

14. The web transfer apparatus according to claim 12, wherein
an expansion angle of the plurality of rollers is larger at the roller arranged outside than at the roller arranged inside.

15. The web transfer apparatus according to claim 13, wherein
an expansion angle of the plurality of rollers is larger at the roller arranged outside than at the roller arranged inside.

16. The web transfer apparatus according to claim 8, wherein
the pair of nip rollers are rubber rollers.

17. The web transfer apparatus according to claim 15, wherein
the pair of nip rollers are rubber rollers.

18. The web transfer apparatus according to claim 8, wherein
the web transfer apparatus is provided in a decompression chamber.

19. The web transfer apparatus according to claim 17, wherein
the web transfer apparatus is provided in a decompression chamber.
